(19) United States
(12) Patent Application Publication
(10) Pub. No.: US 2024/0270533 A1
(43) Pub. Date: Aug. 15, 2024

(54) THERMAL HISTORY ESTIMATION APPARATUS

(71) Applicant: ASAHI KASEI KABUSHIKI KAISHA, Tokyo (JP)

(72) Inventors: Satoru TAKAHASHI, Tokyo (JP); Yuya FUJIMOTO, Tokyo (JP)

(73) Assignee: ASAHI KASEI KABUSHIKI KAISHA, Tokyo (JP)

(21) Appl. No.: 18/436,537

(22) Filed: Feb. 8, 2024

(30) Foreign Application Priority Data
Feb. 14, 2023 (JP) 2023-020720
Dec. 11, 2023 (JP) 2023-208539

(51) Int. Cl. B65H 43/08; H05B 1/02

(52) U.S. Cl. CPC B65H 43/08; H05B 1/0294; B65H 2515/40; B65H 2515/60; B65H 2551/21; B65H 2551/29; B65H 2557/64; B65H 2701/193

(57) ABSTRACT

It is one object of the present invention to provide a thermal history estimation apparatus, a thermal history estimation method and a thermal history estimation program that can estimate variation in thermal history within a plane of a sheet heated by a heating apparatus. The thermal history estimation apparatus includes a first acquisition unit that acquires color information on a sheet plane heated by the heating apparatus, and a first estimation unit that estimates information on variation in thermal history on the sheet plane based on the acquired color information.

### BACKGROUND OF THE INVENTION

### Field of the Invention

The present invention relates to a thermal history estimation apparatus.

### Description of the Related Art

In a process of manufacturing a sheet product, various processes such as heating, cooling, stretching, pressurization, lamination and peeling are applied using, for example, a roll-to-roll method. As the sheet product becomes larger, variation may occur in each of the above-described processes within a plane of the product. When heating process is performed using, for example, the roll-to-roll method, differences in thermal history may occur at various locations in a width direction or a flow direction. Such in-plane differences in processing may lead to characteristic differences within the plane of the sheet product.

As a heating history estimation apparatus, for example, Japanese Patent Laid-Open No. 2018-004571 discloses an apparatus that estimates a heating history based on fluorescent fingerprint information of foods containing amino compounds. However, Japanese Patent Laid-Open No. 2018-004571 does not disclose any apparatus that estimates a heating history of a sheet product other than foods. Japanese Patent No. 6866318 discloses an apparatus provided with a temperature detection unit as a temperature detection label that can be used for purposes such as quality management of fresh foods, medical products or the like.

It is difficult to determine variation in thermal history within a plane of a large sheet product using conventional temperature measurement methods. Thus, when evaluating characteristics of the sheet product, it is difficult to identify whether the characteristic variation derives from the quality of sheet base material or derives from variation in thermal history within the plane, and so it has been difficult to provide more detailed quality management and achieve further quality improvement.

The present invention has been made in view of the above-described problems, and it is an object of the present invention to provide a thermal history estimation apparatus, a thermal history estimation method and a thermal history estimation program which can estimate variation in thermal history within the plane of a sheet heated by a heating apparatus.

Furthermore, the present invention can provide a heat treated sheet evaluation apparatus, a heating apparatus evaluation apparatus and a heating apparatus monitoring apparatus.

### SUMMARY OF THE INVENTION

In other words, the present invention is as follows.

[1]

A thermal history estimation apparatus including

a first acquisition unit that acquires color information on a sheet plane heated by a heating apparatus, and

a first estimation unit that estimates information on variation in thermal history on the sheet plane based on the acquired color information.

[2]

The thermal history estimation apparatus according to [1],

in which the first acquisition unit acquires the color information on the entire sheet plane.

[3]

The thermal history estimation apparatus according to [1] or [2],

in which the first estimation unit estimates information on variation in thermal history on the sheet plane based on the acquired color information and information on a heating time set in the heating apparatus that heats the sheet.

[4]

The thermal history estimation apparatus according to any one of [1] to [3],

in which the first estimation unit estimates a heating temperature as the thermal history assuming that the heating temperature is constant during the heating time.

[5]

The thermal history estimation apparatus according to any one of [1] to [4],

in which the sheet is a laminated body provided with at least a first layer and a second layer,

the first acquisition unit acquires color information of the second layer as the color information on the sheet plane, and

the first estimation unit estimates information on thermal history of the first layer based on the acquired color information of the second layer.

[6]

The thermal history estimation apparatus according to any one of [1] to [5], further including

a composition unit that provides a plurality of first images representing small regions of the sheet and composes the plurality of first images to obtain a second image representing a large region of the sheet,

in which the first acquisition unit acquires the color information of the sheet based on the second image.

[7]

The thermal history estimation apparatus according to any one of [1] to [6],

in which the first acquisition unit further includes a composition unit that acquires a plurality of items of color information of small regions of the sheet and composes the plurality of items of color information of the small regions to obtain color information of a large region of the sheet.

[8]

The thermal history estimation apparatus according to any one of [1] to [7], further including

a display control unit that controls displaying of the information on variation in thermal history using a heat map corresponding to the sheet plane.

[9]

The thermal history estimation apparatus according to any one of [1] to [8], further including

a learning unit that creates a model based on learning data,

in which the learning data includes the color information of the heated sheet and information on a heating condition thereof, and

the first estimation unit estimates information on variation in thermal history on the sheet plane using the model based on the acquired color information.

[10]

A thermal history estimation method including,

executing, by a thermal history estimation apparatus,

an acquisition step of acquiring color information on a sheet plane heated by a heating apparatus, and

an estimation step of estimating information on variation in thermal history on the sheet plane based on the acquired color information.

[11]

A thermal history estimation program causing a thermal history estimation apparatus to execute

an acquisition step of acquiring color information on a sheet plane heated by a heating apparatus, and

an estimation step of estimating information on variation in thermal history on the sheet plane based on the acquired color information.

[12]

The thermal history estimation program according to [11],

in which the acquisition step acquires the color information on the entire sheet plane.

[13]

The thermal history estimation program according to [11] or [12],

in which the estimation step estimates information on variation in thermal history on the sheet plane based on the acquired color information and the information on a heating time set in the heating apparatus that heats the sheet.

[14]

The thermal history estimation program according to any one of [11] to [13],

in which the estimation step estimates a heating temperature as the thermal history assuming that the heating temperature is constant during a heating time.

[15]

The thermal history estimation program according to any one of [11] to [14],

in which the sheet is a laminated body provided with at least a first layer and a second layer,

the acquisition step acquires color information of the second layer as the color information on the sheet plane, and

the estimation step estimates information on thermal history of the first layer based on the acquired color information of the second layer.

[16]

The thermal history estimation program according to any one of [11] to [15], causing the thermal history estimation apparatus to further execute

a composition step of providing a plurality of first images representing small regions of the sheet and composing the plurality of first images to obtain a second image representing a large region of the sheet,

in which the acquisition step acquires the color information of the sheet based on the second image.

[17]

The thermal history estimation program according to any one of [11] to [16],

in which the acquisition step acquiring a plurality of items of color information on small regions of the sheet, and

the thermal history estimation apparatus is further caused to execute

a composition step of composing the plurality of items of color information on the small regions to obtain color information of a large region of the sheet.

[18]

The thermal history estimation program according to any one of [11] to [17], causing the thermal history estimation apparatus to further execute

a display control step of controlling displaying of the information on variation in thermal history using a heat map corresponding to the sheet plane.

[19]

The thermal history estimation program according to any one of [11] to [18], causing the thermal history estimation apparatus to further execute

a learning step of creating a model based on learning data,

in which the learning data includes the color information of the heated sheet and information on a heating condition thereof, and

the estimation step estimates information on variation in thermal history on the sheet plane by the model based on the acquired color information.

[20]

A heat treated sheet evaluation apparatus including

a first acquisition unit that acquires color information on a sheet plane heated by a heating apparatus, and

a second estimation unit that estimates information on characteristic variation on the sheet plane based on the acquired color information.

[21]

The heat treated sheet evaluation apparatus according to [20], further including

a feedback control unit that performs feedback control of the heating apparatus based on the information on characteristic variation and information on a target characteristic.

[22]

The heat treated sheet evaluation apparatus according to [20] or [21],

in which the second estimation unit estimates information on thermal history of the sheet based on the acquired color information, and estimates the information on characteristic variation on the sheet plane based on the information on thermal history.

[23]

A heating apparatus evaluation apparatus including

a first acquisition unit that acquires color information on a sheet plane heated by a heating apparatus, and

a third estimation unit that estimates information on characteristic variation on a plane of a heating part of the heating apparatus based on the acquired color information.

[24]

The heating apparatus evaluation apparatus according to [23],

in which the third estimation unit estimates information on thermal history on the sheet based on the acquired color information, and estimates the information on characteristic variation on the plane of the heating part of the heating apparatus based on the information on thermal history.

[25]

The heating apparatus evaluation apparatus according to [23] or [24], further including

a feedback control unit that performs feedback control of the heating apparatus based on the information on characteristic variation on the plane of the heating part and characteristic information on a target plane of the heating part.

[26]

A heating apparatus monitoring apparatus including

a first acquisition unit that acquires color information on a sheet plane heated by a heating apparatus, and

a monitoring unit that controls a heating condition of the heating apparatus or detects abnormalities in an operating state of the heating apparatus based on the acquired color information.

[27]

The heating apparatus monitoring apparatus according to [26], including

a stop unit that stops operation of the heating apparatus in response to detecting a specific one of the abnormalities.

[28]

The heating apparatus monitoring apparatus according to [26] or [27],

in which the heating apparatus individually controls outputs of two or more heat sources, and

the monitoring unit controls heating conditions of the two or more heat sources based on the acquired color information.

### Advantageous Effects of Invention

It is one object of the present invention to provide a thermal history estimation apparatus, a thermal history estimation method and a thermal history estimation program that can estimate variation in thermal history within a plane even when a sheet product is large. Moreover, the present invention can provide a heat treated sheet evaluation apparatus, a heating apparatus evaluation apparatus and a heating apparatus monitoring apparatus.

### BRIEF DESCRIPTION OF THE DRAWINGS

FIG. 1 is a schematic cross-sectional view illustrating a configuration of a heating apparatus;

FIG. 2 is a schematic view showing information on thermal history of a fourth sheet obtained by a configuration example of the heating apparatus described in FIG. 1 using a heat map;

FIG. 3A is a block diagram illustrating an example of functional configuration of a thermal history estimation apparatus of the present embodiment;

FIG. 3B is a diagram illustrating one aspect of sheet data of the present embodiment;

FIG. 3C is a diagram illustrating one aspect of a table recording a relationship with thermal history in the present embodiment;

FIG. 3D is a flowchart illustrating one aspect of operation processing of the thermal history estimation apparatus of the present embodiment;

FIG. 3E is a flowchart illustrating one aspect of a step of acquiring color information on the sheet plane of the present embodiment;

FIG. 3F is a diagram illustrating an example of a model for estimating variation in thermal history;

FIG. 3G is a flowchart illustrating one aspect of operation processing of the thermal history estimation apparatus of the present embodiment;

FIG. 4A is a block diagram illustrating an example of functional configuration of a heat treated sheet evaluation apparatus of the present embodiment;

FIG. 4B is a flowchart illustrating one aspect of operation processing of the heat treated sheet evaluation apparatus of the present embodiment;

FIG. 4C is a diagram illustrating an example of a model for estimating variation in performance of the heat treated sheet;

FIG. 4D is a diagram illustrating an example of a model for estimating variation in performance of the heat treated sheet;

FIG. 5A is a block diagram illustrating an example of functional configuration of a heating apparatus evaluation apparatus of the present embodiment;

FIG. 5B is a flowchart illustrating one aspect of operation processing of the heating apparatus evaluation apparatus of the present embodiment;

FIG. 5C is a flowchart illustrating one aspect of a step of estimating information on characteristic variation on the plane of a heating part of the heating apparatus based on color information of the present embodiment;

FIG. 5D is a diagram illustrating an example of a model for estimating variation in performance on the plane of the heating part of the heating apparatus;

FIG. 5E is a diagram illustrating an example of a model for estimating variation in performance on the plane of the heating part of the heating apparatus;

FIG. 6A is a block diagram illustrating an example of functional configuration of a heating apparatus monitoring apparatus of the present embodiment;

FIG. 6B is a flowchart illustrating one aspect of operation processing of the heating apparatus monitoring apparatus of the present embodiment; and

FIG. 6C is a flowchart illustrating one aspect of a step of controlling a heating condition of the heating apparatus or detecting abnormality in the operating state of the heating apparatus based on color information of the present embodiment.

### DETAILED DESCRIPTION OF THE PREFERRED EMBODIMENTS

Hereinafter, embodiments of the present invention (hereinafter referred to as “present embodiments”) will be described in detail with reference to the accompanying drawings when necessary. However, the present invention will not be limited to the embodiments, and can be modified in various ways without departing from the spirit and scope of the present invention. Note that the same reference numerals are assigned to identical elements in the drawings and duplicate descriptions will be omitted. Positional relationships such as top, bottom, left, and right will be based on positional relationships shown in the drawings unless otherwise specified. Furthermore, dimensional ratios shown in the drawings are not limited to the ratios shown in the drawings.

### 1. Heating Apparatus

First of all, an example of a heating apparatus will be described. FIG. 1 is a schematic cross-sectional view illustrating a configuration of a heating apparatus 600.

The heating apparatus 600 includes a first roll 621 that unrolls a first sheet 611, a second roll 622 that unrolls a second sheet 612, a fourth roll 624 that rolls up the first sheet 611, a third roll 623 that rolls up the second sheet 612, a heating unit 640 and a control unit 660.

The first roll 621 and the second roll 622 can also be configured to unroll the first sheet 611 and the second sheet 612, respectively. Unrolling the first sheet 611 and the second sheet 612 by the first roll 621 and the second roll 622 may be controlled by the control unit 660.

The unrolled first sheet 611 and second sheet 612 are led onto the heating unit 640. The first sheet 611 and the second sheet 612 may be laminated and heated on the heating unit 640.

A laminated body of the first sheet 611 and the second sheet 612 pressure-laminated in this way is separated into parts and rolled up. For example, the separated first sheet 611 is rolled up into the fourth roll 624 and the second sheet 612 is rolled up into the third roll 623.

An example of constructing a laminated body has been shown above. Without being limited to this, there can also be an aspect in which a single-layer sheet is heated over the heating unit 640. Moreover, the laminated body of the first sheet 611 and the second sheet 612 may be rolled up without being separated.

The above-described configuration example of the heating apparatus is only an example illustrating an aspect in which a sheet is subjected to heat treatment using a roll-to-roll method, and the heating apparatus in the present embodiment is not limited to the above. For example, there can also be an aspect in which a sheet being transported on a conveyor is heated with warm air, a heater or other heat sources. In any case, when a sheet is subjected to heat treatment as shown in the above-described example, or when a sheet is subjected to heat treatment using other methods, a thermal history of the sheet may not necessarily be uniform within the plane due to temperature non-uniformity or the like of a heating medium such as the heating unit 640.

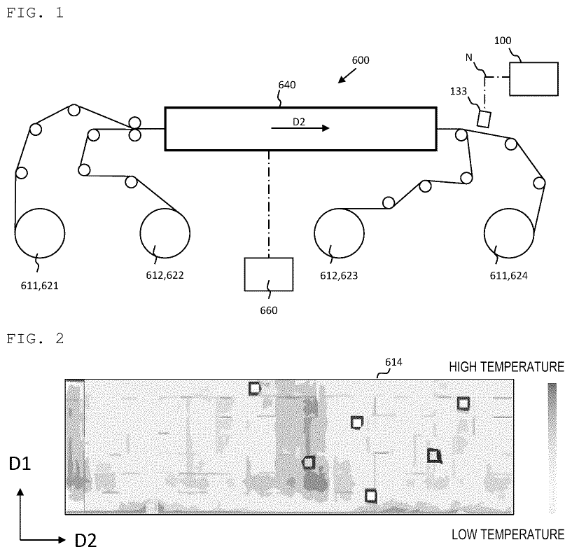

As an example, FIG. 2 shows a schematic view illustrating information on thermal history of the second sheet 612 obtained by the configuration example of the heating apparatus described in FIG. 1 using a heat map. Here, a D1 direction is a width direction (TD) of the second sheet 612, which is a direction parallel to the width direction of the heating roller in FIG. 1. On the other hand, a D2 direction is a flow direction (MD) of the second sheet 612, which is a direction in which each sheet flows on the heating apparatus in FIG. 1. The heat map shown in FIG. 2 shows different heating temperatures at different locations within a plane assuming that the processing time is constant. This heat map indicates that areas that have undergone high temperature treatment are darker in color.

As shown in FIG. 2 schematically, even when a set temperature of the heating apparatus is adjusted, variation actually occurs in thermal history within the sheet plane. Such non-uniformity of the thermal history can also make characteristics within the sheet plane obtained through heat treatment non-uniform. Thus, it is desirable to evaluate variation in thermal history within the sheet plane and use the information for manufacturing or the like.

However, conventionally, there has been no means for evaluating thermal history variation on large sheet planes. By contrast, according to the thermal history estimation apparatus of the present embodiment, thermal history variation on the sheet planes can be evaluated. Hereinafter, the thermal history estimation apparatus and related apparatuses will be described in detail.

### 2. Thermal History Estimation Apparatus

A thermal history estimation apparatus of the present embodiment includes a first acquisition unit that acquires color information on a sheet plane heated by a heating apparatus and a first estimation unit that estimates information on variation in thermal history on the sheet plane based on the acquired color information.

In this way, it is possible to estimate information on variation in thermal history on the sheet plane based on the color information on the sheet plane. If, for example, color information on the sheet plane is obtained using an image pickup apparatus, it may be possible to estimate information on variation in thermal history on the sheet plane based on dark and light colored areas or the like of the information. This makes it possible to estimate variation not in local thermal history, but in thermal history over a wider range within the plane of a sheet product.

Note that “thermal history” in the present embodiment is a history of temperature changes undergone by the sheet through the heating apparatus. The thermal history may include information on a heating temperature and a heating time. The thermal history may also include information on temperature fluctuation during heat treatment or the thermal history may be one based on an assumption that processing has been done at a constant average temperature during the heat treatment without considering temperature fluctuation during the heat treatment.

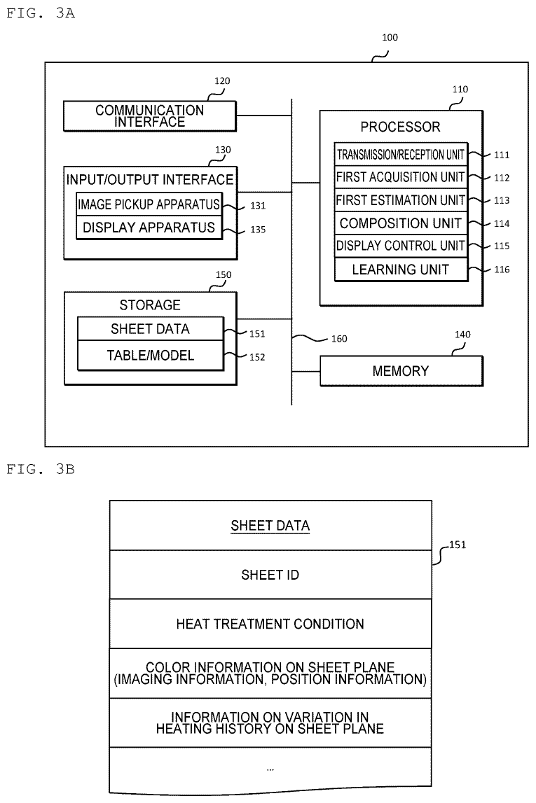

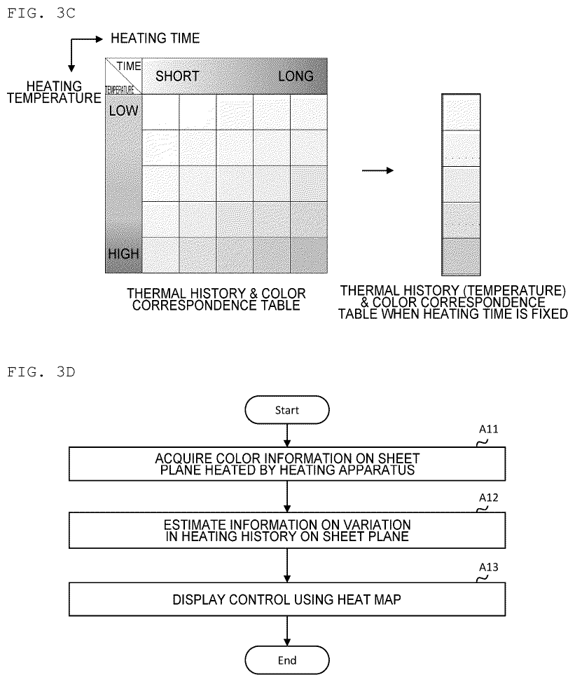

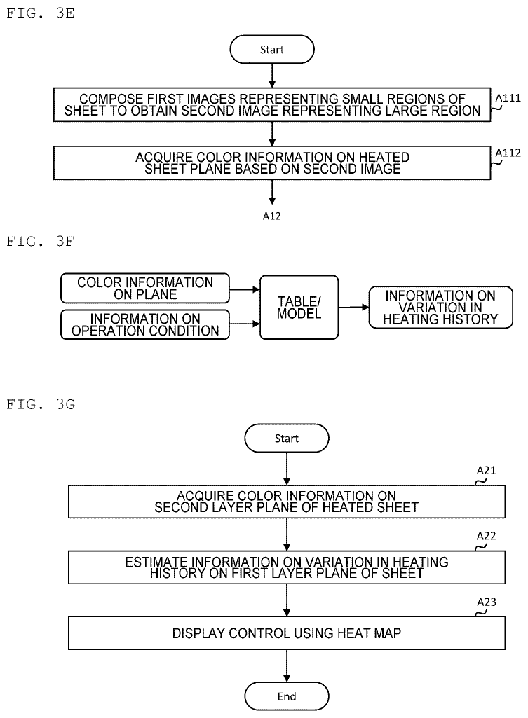

According to the present embodiment, for example, a thermal history estimation apparatus 100 may be connected to other apparatuses via wired or wireless network N to acquire or output any given information. The thermal history estimation apparatus 100 may acquire at least part of information from other apparatuses such as a server connected via the network N or may also be configured to cause other apparatuses such as a server connected via the network N to execute at least part of the processing of functional units shown in FIG. 3A.

### 2.1. Configuration

A hardware configuration of the thermal history estimation apparatus 100 will be described with reference to FIG. 3A. The thermal history estimation apparatus 100 includes, for example, a processor 110, a communication interface 120, an input/output interface 130, a memory 140, a storage 150 and one or more communication buses 160 to mutually connect these components.

The processor 110 executes a process, a function or a method implemented by code or instruction included in a program stored in the storage 150. The processor 110 includes at least one central processing unit (CPU), MPU (Micro Processing Unit), GPU (Graphics Processing Unit), microprocessor, processor core, multiprocessor, ASIC (Application-Specific Integrated Circuit) or FPGA (Field Programmable Gate Array) shown as examples but not limited thereto, to implement their respective processes, functions or methods disclosed in each embodiment by a logic circuit (hardware) or dedicated circuit formed in an integrated circuit ((IC chip), LSI (Large Scale Integration)) or the like.

The processor 110 executes a process, a function or a method implemented by code or instruction included in a program stored in the storage 150. As shown in FIG. 3A, the processor 110 of the present embodiment may be configured to function as a transmission/reception unit 111, a first acquisition unit 112, a first estimation unit 113, a composition unit 114, a display control unit 115 and a learning unit 116.

The communication interface 120 performs various data transmission/reception to/from other apparatuses via a network. Such communication may be carried out by either wired or wireless means, and using any kind of communication protocol as long as mutual communication can be carried out. For example, the communication interface 120 is implemented by hardware such as a network adapter, various kinds of communication software or as a combination thereof.

The network may also be Ad Hoc Network, the intranet, extranet, virtual private network (VPN), local area network (LAN), wireless LAN (WLAN), wide area network (WAN), wireless WAN (WWAN), Metropolitan Area Network (MAN), part of the Internet, part of public switched telephone network (PSTN), mobile phone network, ISDNs (Integrated Service Digital Networks), wireless LANs, LTE (Long Term Evolution), CDMA (Code Division Multiple Access), Bluetooth (R), satellite communication or the like, as examples but not limited thereto, or a combination thereof. The network can include one or more networks.

The input/output interface 130 includes an input apparatus to input various operations to the thermal history estimation apparatus 100 and an output apparatus to output processing results processed in the thermal history estimation apparatus 100. For example, the input/output interface 130 may include an information input apparatus such as a keyboard, a mouse, a touch panel and an image pickup apparatus 133, and an information output apparatus such as a display apparatus 135. Note that the thermal history estimation apparatus 100 may receive predetermined input or execute predetermined output by connecting the external input/output interface 130.

For example, the thermal history estimation apparatus 100 may be connected to the image pickup apparatus 133 via the wired or wireless network N as the external input/output interface 130. The thermal history estimation apparatus 100 may be connected to the control unit that drives the heating apparatus 600 via the wired or wireless network N.

The memory 140 temporarily stores a program loaded from the storage 150 and provides a work area to the processor 110. The memory 140 also temporarily stores various kinds of data generated while the processor 110 is running a program. The memory 140 may be, for example, a high-speed, random access memory such as DRAM, SRAM, DDR RAM or other random access solid storage apparatuses or the like or a combination thereof.

The storage 150 stores programs, functional units and various kinds of data. The storage 150 may be, for example, one or more non-volatile memories, such as magnetic disk storage apparatuses, optical disk storage apparatuses, flash memory devices or other non-volatile solid storage apparatuses, or a combination thereof. Another example of the storage 150 can be at least one storage apparatus installed remotely from the processor 110.

The storage 150 may record sheet data 151 that records sheet information, tables used for various estimation processes, or algorithms or models used for the various estimation processes (hereinafter referred to as “table/model 152”).

An operating system includes, for example, procedures to process various basic system services and execute tasks using hardware.

The transmission/reception unit 111 may function as a transmission unit that transmits various information to other apparatuses, for example, via the communication interface 120 and the network N or as a reception unit that receives various information from the other apparatuses.

The first acquisition unit 112 acquires color information on the sheet plane heated by the heating apparatus. The first acquisition unit 112 may acquire color information on the entire sheet plane or acquire color information in part of the sheet.

Color information on the sheet plane may be sheet imaging information captured by the image pickup apparatus 133. The imaging information may be a copy of the entire sheet or a copy of part of the sheet. Color information on the sheet plane preferably includes at least color information of the entire sheet plane in the width direction (D1 direction). For example, the color information on the sheet plane includes no color information on the sheet plane at ends in the sheet flow direction (D2 direction) and may include color information of the entire sheet plane in the width direction (D1 direction) in the region between the ends.

Furthermore, the imaging information may be a still image or a movie. For example, the first acquisition unit 112 may acquire a sheet flowing on the heating apparatus 600 as a movie and use the movie as color information on the sheet plane heated by the heating apparatus. The color information on the sheet plane may be color information on the sheet surface or may be color information on the back of the sheet. When the sheet is a laminated body, the color information may be color information on any surface.

The sheet of the present embodiment may be a laminated body with two or more layers. For example, when the sheet is a laminated body provided with at least a first layer and a second layer, the first acquisition unit 112 may acquire color information of the second layer and the first estimation unit 113 may estimate information on thermal history of the first layer based on the acquired color information of the second layer. Here, the second layer used to estimate the information on thermal history of the first layer may be made of paper or resin.

In addition, the first acquisition unit 112 may record the acquired color information on the sheet plane in the sheet data 151 if necessary. In this case, the first acquisition unit 112 preferably records the color information on the sheet plane in association with the position information of the location on the sheet corresponding to the color information. More specifically, although not particularly limited, the position of the imaging information on the long second sheet 612 may be identified from the sheet flowing speed on the heating apparatus and the time of capturing of the imaging information and may be associated with the color information on the sheet plane.

The first acquisition unit 112 may acquire a heat treatment condition from the heating apparatus if necessary and record the heat treatment condition in the sheet data 151. Although not particularly limited, the heat treatment condition may include, in addition to a flow speed, information on a set temperature or the like of a heating medium of the heating unit 640, an air flow rate or a pressure of a heating apparatus with suction or a floating transport apparatus, tension of each sheet and thickness of the sheet or the like.

Various kinds of information on the sheet may be recorded in the sheet data 151. For example, as shown in FIG. 3B, a sheet ID such as a lot number to uniquely identify the sheet, a heat treatment condition of the sheet, color information on the sheet plane acquired and recorded by the first acquisition unit 112, information on variation in thermal history on the sheet plane estimated by the first estimation unit, which will be described later, may be recorded in the sheet data 151.

In addition, the first acquisition unit 112 may acquire such information from other apparatuses, for example, via the network N, or through user input via the input/output interface. The first acquisition unit 112 may store the acquired information in various databases. Note that the first estimation unit 113, which will be described later, may use the information stored in the various databases.

The first estimation unit 113 estimates information on variation in thermal history on the sheet plane based on the acquired color information. The first estimation unit 113 may refer to a table recording a relationship between color and thermal history in advance, and estimate information on variation in thermal history on the sheet plane based on the acquired color information. The first estimation unit 113 may record information on variation in thermal history on the estimated sheet plane in the sheet data 151.

FIG. 3C shows a table recording a relationship between color and thermal history. This table shows one aspect of the table/model 152. The table records color data when a sheet is subjected to heat treatment, for example, at a predetermined temperature and for a predetermined time. As other conditions, the table may record color data when the sheet is subjected to heat treatment at a predetermined temperature, at air flow rate and with a pressure of a heating apparatus with suction or a floating transport apparatus.

The first estimation unit 113 may identify a color similar to the acquired color information from among colors recorded in the table/model 152 and estimate the heat treatment condition corresponding to the identified color as the thermal history. In this case, the first estimation unit 113 may refer to the heat treatment condition of the sheet data 151. For example, when a heating time can be identified according to the heat treatment condition, the first estimation unit 113 may estimate information on variation in thermal history on the sheet plane based on the acquired color information and information on the heating time set by the heating apparatus 600 that heats the sheet. In this way, as shown in FIG. 3C, the first estimation unit 113 can estimate the thermal history with reference to only the color corresponding to the identified heating time from among colors in the table/model 152. This allows the estimation speed and the accuracy of estimation to improve further.

The first estimation unit 113 may estimate the heating temperature when the heating temperature is assumed to be constant during the heating time as the thermal history. By assuming that the heating temperature does not fluctuate during the heating time, it is possible to simplify estimation processing of the thermal history and improve the processing speed.

The composition unit 114 may provide a plurality of first images representing small regions of the sheet and compose the plurality of first images to obtain a second image representing a large region of the sheet. In this case, the first acquisition unit 112 may acquire color information of the sheet based on the second image. The processing procedure may be reversed so that the first acquisition unit 112 may acquire a plurality of items of color information in the small regions of the sheet and the composition unit 114 may compose the plurality of items of color information of the small regions to obtain color information of a large region of the sheet.

Accordingly, even when an area of the first images that can be captured is small due to limitations to a viewing angle of the image pickup apparatus 133, it is possible to compose a larger second image from the first images and estimate information on variation in thermal history on the sheet plane.

The display control unit 115 may control displaying of the information on variation in thermal history using a heat map corresponding to the sheet plane. The heat map expresses variation in thermal history within the sheet plane with color intensity. Color stages in the heat map are not particularly limited. If, for example, the number of color stages is assumed to be two, the heat map corresponds to bivalent mapping.

The thermal history estimation apparatus 100 may include a learning unit 116 that creates a model based on learning data. In this case, the first estimation unit 113 can use a machine learning model created by the learning unit 116 instead of the above-described table (learning step). More specifically, the first estimation unit 113 estimates information on variation in thermal history on the sheet plane using a model based on the acquired color information.

The learning data used in this case is not particularly limited as long as it includes the color information of the heated sheet and information on the heating condition.

The method for creating a model is not particularly limited, and conventionally known methods can be used. It is possible to adopt, for example, neural networks such as logistic regression model, multilayer perceptron, CNN (Convolutional Neural Network) and RNN (Recurrent Neural Network), a support vector machine using any given kernel function like Gaussian kernel, a random forest modelled as a regression tree, models using multiple regression analysis, hidden Markov model or the like, and various other models such as statistical model and probability model. Furthermore, a model combining various models to make a comprehensive judgment can also be adopted.

Furthermore, the learning unit 116 may collect learning data periodically to update the model by relearning.

### 2.2. Operation Processing

Next, operation of the thermal history estimation apparatus 100 will be described. FIG. 3D is a flowchart illustrating an example of processing performed by the thermal history estimation apparatus 100.

In step A11, the first acquisition unit 112 of the thermal history estimation apparatus 100 acquires color information on the sheet plane heated by the heating apparatus. In this case, as shown in FIG. 3E, the composition unit 114 may provide a plurality of first images representing small regions of a sheet and compose the plurality of first images to obtain a second image representing a large region of the sheet (step A111), and the first acquisition unit 112 may acquire color information of the sheet based on the second image (step A112, composition step). Although not shown, the first acquisition unit 112 may acquire a plurality of items of color information of the small regions of the sheet in the same manner as above, and the composition unit 114 may compose the plurality of items of color information of the small regions and obtain color information of the large region of the sheet (composition step).

In step A12, the first estimation unit 113 of the thermal history estimation apparatus 100 estimates information on variation in thermal history on the sheet plane based on the acquired color information. In this case, as shown in FIG. 3F, a table recording a relationship between color and thermal history or a model that has learnt a relationship between color and thermal history may also be used as the table/model 152. Furthermore, the first estimation unit 113 may estimate information on variation in thermal history on the sheet plane by taking into account information on the heat treatment condition in addition to the color information.

In step A13, the display control unit 115 of the thermal history estimation apparatus 100 controls displaying of the information on variation in thermal history on the sheet plane using a heat map (display control step).

FIG. 3G shows a flowchart illustrating another example of processing carried out by the thermal history estimation apparatus 100. FIG. 3G illustrates an aspect in which, when the sheet is a laminated body provided with at least a first layer and a second layer, the first acquisition unit 112 acquires color information of the second layer (step A21), the first estimation unit 113 estimates information on thermal history of the first layer based on the acquired color information of the second layer (step A22), and the display control unit 115 controls displaying of the result (step A23).

### 2.3. Thermal History Estimation Method

According to the thermal history estimation method of the present embodiment, the thermal history estimation apparatus performs an acquisition step of acquiring color information on the sheet plane heated by the heating apparatus and an estimation step of estimating information on variation in thermal history on the sheet plane based on the acquired color information.

Note that since specific aspects of the method of the present embodiment have been described in the above-described operation processing, detailed descriptions are omitted here.

### 2.4. Thermal History Estimation Program

The thermal history estimation program of the present embodiment causes the thermal history estimation apparatus to execute an acquisition step of acquiring color information on the sheet plane heated by a heating apparatus and an estimation step of estimating information on variation in thermal history on the sheet plane based on the acquired color information.

The program may be one recorded in a readable recording medium. Note that since specific aspects of the processing executed by the program of the present embodiment have been described in the above-described operation processing, detailed descriptions are omitted here.

### 3. Heat Treated Sheet Evaluation Apparatus

A heat treated sheet evaluation apparatus 200 of the present embodiment includes a first acquisition unit that acquires color information on a sheet plane heated by a heating apparatus, and a second estimation unit that estimates information on characteristic variation on the sheet plane based on the acquired color information.

In this way, it is possible to estimate information on characteristic variation on the sheet plane subjected to heat treatment. In particular, characteristic variation over a wider range within the plane of a sheet product can be estimated instead of local characteristics.

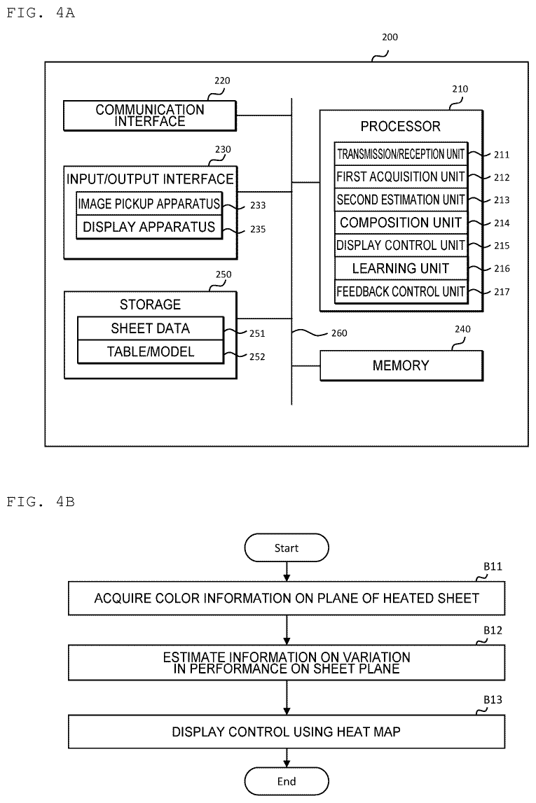

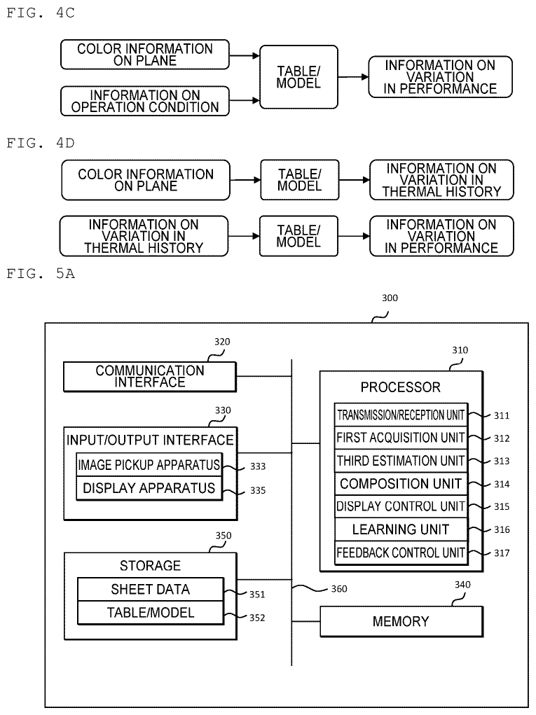

In the present embodiment, for example, the heat treated sheet evaluation apparatus 200 may be connected to other apparatuses via a wired or wireless network N in order to acquire or output any given information. The heat treated sheet evaluation apparatus 200 may acquire at least part of information from other apparatuses such as a server connected via the network N or at least part of processing of functional units shown in FIG. 4A may be configured to be executed by other apparatuses such as a server connected via the network N.

### 3.1. Configuration

A hardware configuration of the heat treated sheet evaluation apparatus 200 will be described with reference to FIG. 4A. The heat treated sheet evaluation apparatus 200 includes, for example, a processor 210, a communication interface 220, an input/output interface 230, a memory 240, a storage 250 and one or more communication buses 260 to mutually connect these components.

As shown in FIG. 4A, the processor 210 of the present embodiment can be configured to function as a transmission/reception unit 211, a first acquisition unit 212, a second estimation unit 213, a composition unit 214, a display control unit 215, a learning unit 216 and a feedback control unit 217. Regarding the other points, since the configuration of the processor 210, a communication interface 220, an input/output interface 230, a memory 240, a storage 250 and a communication bus 260 can be similar to the configuration of the processor 110, the communication interface 120, the input/output interface 130, the memory 140, the storage 150 and the communication bus 160, their descriptions are omitted.

Note that since an image pickup apparatus 231 and a display apparatus 235 can also be similar to the image pickup apparatus 131 and the display apparatus 135, their descriptions are omitted. In addition, since sheet data 251 and a table/model 252 can also be similar to the sheet data 151 and the table/model 152, their descriptions are omitted.

The transmission/reception unit 211 may be configured to function as a transmission unit that transmits various information to other apparatuses, for example, via the communication interface 220 and the network N or as a reception unit that receives various information from other apparatuses.

The first acquisition unit 212 acquires color information on the sheet plane heated by the heating apparatus. Since the first acquisition unit 212 can be similar to the first acquisition unit 112, its descriptions are omitted.

The second estimation unit 213 estimates information on characteristic variation on the sheet plane based on the acquired color information. The second estimation unit 213 may refer to a table recording a relationship between colors and characteristics in advance and estimate information on variation in thermal history on the sheet plane based on the acquired color information or may estimate information on variation in thermal history on the sheet plane based on color information acquired using a model that has learnt a relationship between colors and characteristics.

Furthermore, the second estimation unit 213 may estimate information on thermal history of the sheet based on the acquired color information and estimate information on characteristic variation on the sheet plane based on the information on the thermal history. When estimating the information on thermal history of the sheet based on the acquired color information, the second estimation unit 213 can use the model or the table described in the thermal history estimation apparatus. On the other hand, when estimating information on characteristic variation on the sheet plane based on the information on thermal history, the second estimation unit 213 can use a model or the like created using learning data that associates the information on thermal history and the information on characteristic variation on the sheet plane.

This allows the model or table used in the thermal history estimation apparatus to be diverted. This also makes it easier to create a model created using learning data that associates the information on thermal history and the information on characteristic variation on the sheet plane.

The composition unit 214 may provide a plurality of first images representing small regions of the sheet and compose the plurality of first images to obtain a second image representing a large region of the sheet. In this case, the first acquisition unit 212 may acquire color information of the sheet based on the second image. The processing procedure may be reversed so that the first acquisition unit 212 may acquire a plurality of items of color information on small regions of the sheet and the composition unit 214 may compose the plurality of items of color information of the small regions to acquire color information of the large region of the sheet.

The display control unit 215 may control displaying of information on characteristic variation using a heat map corresponding to the sheet plane. The heat map expresses characteristic variation within the sheet plane with color intensity. Color stages in the heat map are not particularly limited.

The learning unit 216 creates a model based on learning data. The learning data may include color information of the heated sheet and the characteristic information of the corresponding sheet. The second estimation unit 213 may estimate the information on characteristic variation on the sheet plane using the model based on the acquired color information.

The model creation method is not particularly limited and conventionally known methods can be used. It is possible to adopt, for example, neural networks such as logistic regression model, multilayer perceptron, CNN (Convolutional Neural Network) and RNN (Recurrent Neural Network), a support vector machine using any given kernel function like Gaussian kernel, a random forest modelled as a regression tree, models using multiple regression analysis, hidden Markov model or the like, and various other models such as statistical model and probability model. A model combining various models to make a comprehensive judgment can also be adopted.

Furthermore, the learning unit 216 may collect learning data periodically and update the model through relearning.

The feedback control unit 217 may perform feedback control of the heating apparatus based on information on characteristic variation and information on target characteristic. More specifically, it may be possible to perform feedback control on the basis of a difference between the information on characteristic variation and the information on target characteristic to change heat treatment conditions of the heating apparatus so as to eliminate the difference. This allows the temperature of the heating apparatus to be lowered in areas that have been subjected to heat treatment excessively and increased in areas where heat treatment is insufficient.

### 3.2. Operation Processing

Next, operation of the heat treated sheet evaluation apparatus 200 will be described. FIG. 4B is a flowchart illustrating an example of processing performed by the heat treated sheet evaluation apparatus 200.

In step B11, the first acquisition unit 212 of the heat treated sheet evaluation apparatus 200 acquires color information on the sheet plane heated by the heating apparatus. In this case, the composition unit 214 may provide a plurality of first images representing small regions of the sheet and compose the plurality of first images to obtain a second image representing a large region of the sheet, and the first acquisition unit 212 may acquire color information of the sheet based on the second image. Similarly, the first acquisition unit 212 may acquire a plurality of items of color information of the small regions of the sheet, and the composition unit 214 may compose the plurality of items of color information of the small regions to obtain color information of the large region of the sheet.

In step B12, the second estimation unit 213 of the heat treated sheet evaluation apparatus 200 estimates information on characteristic variation on the sheet plane based on the acquired color information. In this case, it may be possible to use a table recording a relationship between colors and characteristics or a model that has learnt a relationship between colors and characteristics. Furthermore, as shown in FIG. 4C, the second estimation unit 213 may estimate information on characteristic variation on the sheet plane by taking into account the information on the heat treatment condition in addition to the color information.

Furthermore, in step B12, as shown in FIG. 4D, the second estimation unit 213 may estimate information on thermal history of the sheet based on the acquired color information and estimate information on characteristic variation on the sheet plane based on the information on thermal history.

In step B13, the display control unit 215 of the heat treated sheet evaluation apparatus 200 controls displaying of the information on characteristic variation on the sheet plane using a heat map.

### 3.3. Characteristic Evaluation Method

According to a characteristic evaluation method of the present embodiment, the heat treated sheet evaluation apparatus 200 executes an acquisition step of acquiring color information on the sheet plane heated by a heating apparatus and an estimation step of estimating information on characteristic variation on the sheet plane based on the acquired color information.

Note that since specific aspects of the method of the present embodiment have been described in the above-described operation processing, detailed descriptions are omitted here.

### 3.4. Characteristic Evaluation Program

A characteristic evaluation program of the present embodiment causes the heat treated sheet evaluation apparatus 200 to execute an acquisition step of acquiring color information on the sheet plane heated by a heating apparatus and an estimation step of estimating information on characteristic variation on the sheet plane based on the acquired color information.

The program may be one recorded in a readable recording medium. Note that since specific aspects of the processing executed by the program of the present embodiment have been described in the above-described operation processing, detailed descriptions are omitted here.

### 4. Heating Apparatus Evaluation Apparatus

A heating apparatus evaluation apparatus of the present embodiment includes a first acquisition unit that acquires color information on a sheet plane heated by a heating apparatus and a third estimation unit that estimates information on characteristic variation on the plane of a heating part of the heating apparatus based on the acquired color information.

In this way, information on characteristic variation on the plane of the heating part of the heating apparatus can be estimated. In particular, characteristic variation over a wider range within the plane of the heating part of the heating apparatus can be estimated instead of local characteristics.

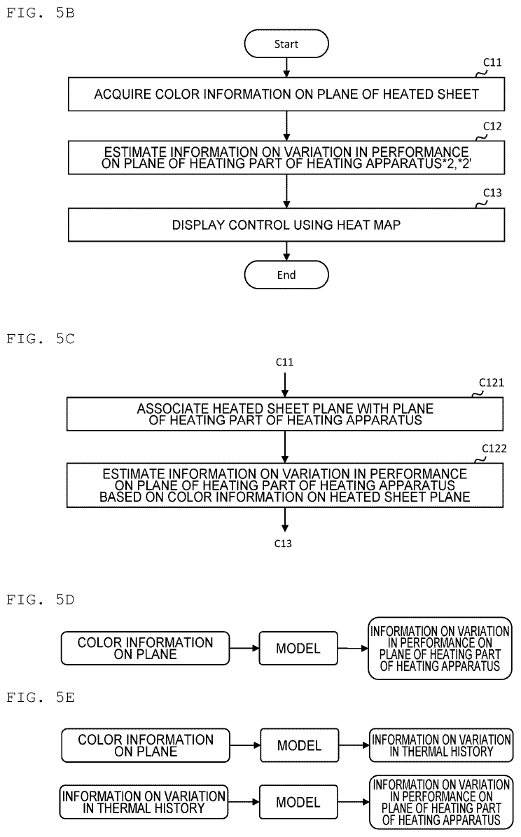

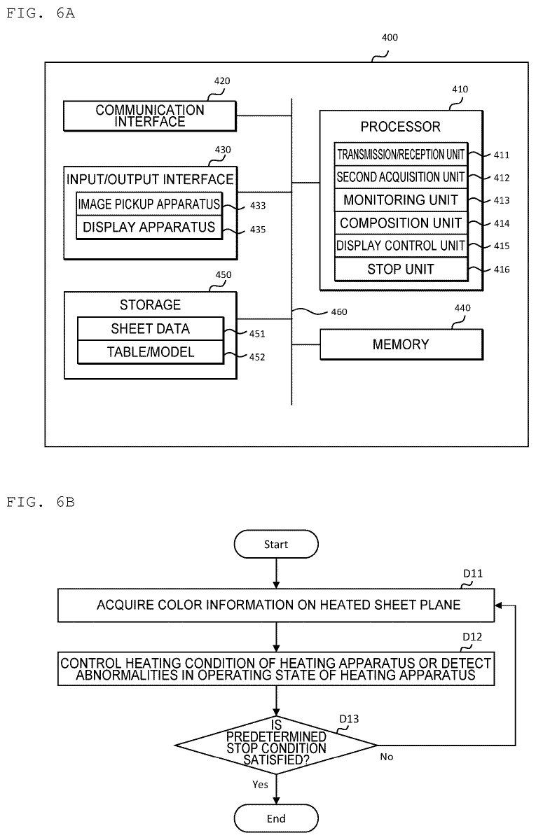

For example, a heating apparatus evaluation apparatus 300 of the present embodiment may be connected to other apparatuses via a wired or wireless network N in order to acquire or output any given information. Furthermore, the heating apparatus evaluation apparatus 300 may acquire at least part of information from other apparatuses such as a server connected via the network N or may also be configured to cause other apparatuses such as a server connected via the network N to execute at least part of processing of functional units shown in FIG. 5A.

### 4.1. Configuration

A hardware configuration of the heating apparatus evaluation apparatus 300 will be described with reference to FIG. 5A. The heating apparatus evaluation apparatus 300 includes, for example, a processor 310, a communication interface 320, an input/output interface 330, a memory 340, a storage 350 and one or more communication buses 360 to mutually connect these components.

As shown in FIG. 5A, the processor 310 of the present embodiment can be configured to function as a transmission/reception unit 311, a first acquisition unit 312, a third estimation unit 313, a composition unit 314, a display control unit 315, a learning unit 316 and a feedback control unit 317. Regarding the other points, since the configuration of the processor 310, the communication interface 320, the input/output interface 330, the memory 340, the storage 350 and the communication bus 360 can be similar to the processor 110, the communication interface 120, the input/output interface 130, the memory 140, the storage 150 and the communication bus 160, their descriptions are omitted.

Note that since the image pickup apparatus 331 and the display apparatus 335 can also be similar to the image pickup apparatus 131 and the display apparatus 135, their descriptions are omitted. Moreover, since the sheet data 351 and the table/model 352 can also be similar to the sheet data 151 and the table/model 152, their descriptions are omitted.

The transmission/reception unit 311 may be configured to function as a transmission unit that transmits various information to other apparatuses, for example, via the communication interface 320 and the network N or a reception unit that receives various information from other apparatuses.

The first acquisition unit 312 acquires color information on the sheet plane heated by a heating apparatus. Since the first acquisition unit 312 can be similar to the first acquisition unit 112, their descriptions are omitted.

The third estimation unit 313 estimates information on characteristic variation on the plane of the heating part of the heating apparatus based on the acquired color information. The third estimation unit 313 may refer to a table recording a relationship between colors and characteristics in advance and estimate information on characteristic variation on the plane of a heating part of the heating apparatus based on the acquired color information, or may use a model that has learnt a relationship between colors and characteristics and estimate information on characteristic variation on the plane of the heating part of the heating apparatus based on the acquired color information.

Note that examples of “characteristic variation on the plane of the heating part of the heating apparatus” may include not only variation in temperature distribution on the surface of the heating unit 640 but also variation in heat transfer properties between the heating unit 640 and the sheet in addition to a temperature distribution of the surface. More specifically, examples of causes for variation in heat transfer properties may include scratches on the surface of the heating unit 640, which causes heat transfer conditions to vary in a localized manner, unevenness that may exist on the surface of the heating unit 640, which causes heat transfer conditions to vary in a localized manner, or misalignment of the heating unit 640, which causes the contact between the surface of the heating unit 640 and the sheet to vary in a localized manner, which eventually causes heat transfer conditions to vary. In the case where the heating unit 640 is provided with a suction mechanism to suck the sheet or in the case where the heating unit 640 is provided with a pressing mechanism to press the sheet against the plane of the heating part, a partial difference in the suction or pressure can cause the heat transfer condition to vary in a localized manner.

The third estimation unit 313 may estimate information on thermal history on the sheet based on the acquired color information and estimate information on characteristic variation on the plane of the heating part of the heating apparatus based on the information on thermal history. When the third estimation unit 313 estimates information on thermal history on the sheet based on the acquired color information, the model or the table described in the thermal history estimation apparatus can be used. On the other hand, when the third estimation unit 313 estimates the information on characteristic variation on the plane of the heating part of the heating apparatus based on the information on thermal history, it is possible to use the model or the like created using learning data that associates the information on thermal history and the information on characteristic variation on the plane of the heating part of the heating apparatus.

This allows the model or the table used in the thermal history estimation apparatus to be diverted. Moreover, this makes it easier to create the model created using learning data that associates the information on thermal history and the information on characteristic variation on the plane of the heating part of the heating apparatus.

The composition unit 314 may provide a plurality of first images representing small regions of the sheet and compose the plurality of first images to obtain a second image representing a large region of the sheet. In this case, the first acquisition unit 312 may acquire color information of the sheet based on the second image. The processing procedure may be reversed so that the first acquisition unit 312 acquires a plurality of items of color information of the small regions of the sheet, and the composition unit 314 composes the plurality of items of color information of the small regions to obtain color information of the large region of the sheet.

The display control unit 315 may control displaying of the information on characteristic variation using a heat map corresponding to the plane of the heating part of the heating apparatus. The heat map expresses characteristic variation within the sheet plane with color intensity. Color stages in the heat map are not particularly limited.

The learning unit 316 creates a model based on the learning data. The learning data may include color information of the heated sheet and the corresponding characteristic information of the heating part of the heating apparatus. The third estimation unit 313 may estimate information on characteristic variation on the plane of the heating part of the heating apparatus using the model based on the acquired color information.

The model creation method is not particularly limited and conventionally known methods can be used. It is possible to adopt, for example, neural networks such as logistic regression model, multilayer perceptron, CNN (Convolutional Neural Network) and RNN (Recurrent Neural Network), a support vector machine using any given kernel function like Gaussian kernel, a random forest modelled as a regression tree, models using multiple regression analysis, hidden Markov model or the like, and various other models such as statistical model and probability model. A model combining various models to make a comprehensive judgment can also be adopted.

Furthermore, the learning unit 316 may collect learning data periodically and update the model through relearning.

The feedback control unit 317 may perform feedback control of the heating apparatus based on the information on characteristic variation on the plane of the heating part and characteristic information on the target plane of the heating part. More specifically, the feedback control unit 317 may perform feedback control on the basis of a difference between the information on characteristic variation on the plane of the heating part and the characteristic information on the target plane of the heating part to change the heat treatment conditions of the heating apparatus so as to eliminate the difference. This allows the temperature of a location of the plane of the heating part that has been excessively subjected to heat treatment to be lowered, and the temperature of a location where heat treatment is insufficient to be increased.

### 4.2. Operation Processing

Next, operation of the heating apparatus evaluation apparatus 300 will be described. FIG. 5B is a flowchart illustrating an example of processing performed by the heating apparatus evaluation apparatus 300.

In step C11, the first acquisition unit 312 of the heating apparatus evaluation apparatus 300 acquires color information on the sheet plane heated by the heating apparatus. In this case, the composition unit 314 may provide a plurality of first images representing small regions of the sheet and compose the plurality of first images to obtain a second image representing a large region of the sheet, and the first acquisition unit 312 may acquire color information of the sheet based on the second image. Likewise, the first acquisition unit 312 may acquire a plurality of items of color information of small regions of the sheet and the composition unit 314 may compose the plurality of items of color information of the small regions to obtain color information of a large region of the sheet.

In step C12, the third estimation unit 313 of the heating apparatus evaluation apparatus 300 estimates information on characteristic variation on the plane of the heating part of the heating apparatus based on the acquired color information. In this case, as shown in FIG. 5C, the third estimation unit 313 may execute an association process of associating the heated sheet plane and the plane of the heating part of the heating apparatus (step C121) and an estimation process of estimating information on characteristic variation on the plane of the heating part of the heating apparatus based on the color information on the heated sheet plane (step C122).

When applying heat treatment using a heat medium such as a heating roll, a variation pattern with the same color or the same thermal history can be formed on the sheet plane for every rotation of the heating roll. In the association in step C121, the association process may be executed based on repetition of variation patterns of the color or thermal history formed on the sheet.

In step C12, the third estimation unit 313 may use a table recording a relationship between colors and characteristics or a model that has learnt a relationship between colors and characteristics as shown in FIG. 5D. Furthermore, the third estimation unit 313 may estimate information on characteristic variation on the sheet plane by taking into account not only color information but also information on the heat treatment condition.

Furthermore, in step C12, the third estimation unit 313 may estimate information on thermal history on the sheet based on the acquired color information as shown in FIG. 5E, and estimate information on characteristic variation on the sheet plane based on the information on thermal history.

In step C13, the display control unit 315 of the heating apparatus evaluation apparatus 300 controls displaying of the information on characteristic variation on the sheet plane using a heat map.

### 4.3. Characteristic Evaluation Method

According to the characteristic evaluation method of the present embodiment, the heating apparatus evaluation apparatus 300 executes an acquisition step of acquiring color information on the sheet plane heated by the heating apparatus and an estimation step of estimating information on characteristic variation on the plane of the heating part of the heating apparatus based on the acquired color information.

Note that since specific aspects of the method of the present embodiment have been described in the above-described operation processing, detailed descriptions are omitted here.

### 4.4. Characteristic Evaluation Program

The characteristic evaluation program of the present embodiment causes the heating apparatus evaluation apparatus 300 to execute an acquisition step of acquiring color information on the sheet plane heated by the heating apparatus and an estimation step of estimating information on characteristic variation on the plane of the heating part of the heating apparatus based on the acquired color information.

The program may be one recorded in a readable recording medium. Note that specific aspects of the processing executed by the program of the present embodiment have been described in the above-described operation processing, and so detailed descriptions are omitted here.

### 5. Heating Apparatus Monitoring Apparatus

A heating apparatus monitoring apparatus 400 of the present embodiment includes a first acquisition unit that acquires color information on the sheet plane heated by a heating apparatus and a monitoring unit that controls a heating condition of the heating apparatus or detects abnormality in an operating state of the heating apparatus based on the acquired color information.

By detecting variation in thermal history based on the acquired color information, performing feedback control of the heating condition of the heating apparatus so as to reduce variation in the heating condition within the plane or monitoring whether the thermal history is deviated from a normal range, it is possible to detect abnormality in the operating state of the heating apparatus, and stop the heating apparatus or issue an alert to an operator if necessary.

There can be various operation aspects of the heating apparatus in addition to the aspect in which a heating temperature is controlled over the entire plane of the sheet, such as an aspect in which the heating temperature is intentionally increased or lowered at parts of the sheet so as to form regions with different characteristics within the sheet. That is, whether the heating temperature is uniform or non-uniform within the sheet plane depends on the operation aspect requested by a user. Therefore, assuming that such non-uniform heating can be realized, it is preferable for the heating apparatus monitoring apparatus to monitor or detect that there is any difference between the operation aspect instructed to the heating apparatus by the user and the actual operating state of the heating apparatus, and correct the difference if any.

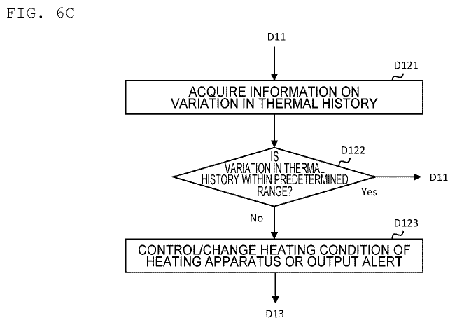

According to the present embodiment, for example, the heating apparatus monitoring apparatus 400 may be connected to other apparatuses via a wired or wireless network N to acquire or output any given information. Moreover, the heating apparatus monitoring apparatus 400 may acquire at least part of information from the other apparatuses such as a server connected via the network N or may be configured to cause the other apparatuses such as a server connected via the network N to execute at least some processing of the functional units shown in FIG. 6A.

### 5.1. Configuration

A hardware configuration of the heating apparatus monitoring apparatus 400 will be described with reference to FIG. 6A. The heating apparatus monitoring apparatus 400 includes, for example, a processor 410, a communication interface 420, an input/output interface 430, a memory 440, a storage 450 and one or more communication buses 460 to mutually connect these components.

As shown in FIG. 6A, the processor 410 of the present embodiment can be configured to function as a transmission/reception unit 411, a first acquisition unit 412, a monitoring unit 413, a composition unit 414, a display control unit 415 and a stop unit 416. Regarding the other points, since the configuration of the processor 410, the communication interface 420, the input/output interface 430, the memory 440, the storage 450 and the communication bus 460 can be similar to the processor 110, the communication interface 120, the input/output interface 130, the memory 140, the storage 150 and the communication bus 160, their descriptions are omitted.

Note that the image pickup apparatus 433 and the display apparatus 435 can also be similar to the image pickup apparatus 131 and the display apparatus 135, and so their descriptions are omitted. Moreover, the sheet data 451 and the table/model 452 can also be similar to the sheet data 151 and the table/model 152, and so their descriptions are omitted.

The transmission/reception unit 411 may function as a transmission unit that transmits various information to other apparatuses, for example, via the communication interface 420 and the network N or as a reception unit that receives various information from the other apparatuses.

The first acquisition unit 412 acquires color information on the sheet plane heated by the heating apparatus. Since the first acquisition unit 412 can be similar to the first acquisition unit 112, descriptions are omitted.

The monitoring unit 413 controls the heating condition of the heating apparatus or detects abnormality in the operating state of the heating apparatus based on the acquired color information.

For example, the monitoring unit 413 may detect variation in thermal history on the sheet plane based on color information on the sheet plane heated by the heating apparatus and perform feedback control of the heating condition of the heating apparatus so as to reduce the variation within the plane. In this case, the monitoring unit 413 may determine whether the detected variation in thermal history is equal to or greater than a predetermined value, and when the variation in thermal history is equal to or greater than the predetermined value, the monitoring unit 413 may perform feedback control of the heating condition of the heating apparatus so as to reduce the variation within the plane.

The control by the monitoring unit 413 may be configured to estimate information on characteristic variation on the plane of the heating part of the heating apparatus based on the information on thermal history of the sheet and control the heating condition of the heating apparatus so as to reduce the variation in the heating condition within the plane based on information on characteristic variation on the plane of the heating part of the heating apparatus, for example. Note that the process of estimating information on characteristic variation on the plane of the heating part of the heating apparatus can be similar to the third estimation unit 313 in the above-described heating apparatus evaluation apparatus, and so descriptions are omitted.

The control by the monitoring unit 413 may be partial or total in-plane control of the heating temperature of the heating unit 640, an air flow rate or a pressure of the heating apparatus with suction or a floating transport apparatus.

In abnormality detection by the monitoring unit 413, whether the operating state of the heating apparatus is normal or abnormal may be detected by monitoring whether the thermal history is deviated from a normal range based on, for example, information on thermal history of the sheet. For example, when the sheet is subjected to heat treatment at an excessively high temperature or low temperature from a preset range of thermal history, the monitoring unit 413 may determine, based on the thermal history of the sheet, that the operating state of the heating apparatus is abnormal.

When abnormality is detected, the monitoring unit 413 can stop the heating apparatus or issue an alert to the operator if necessary. When no abnormality is detected, that is, when the operating state of the heating apparatus is determined to be normal, the monitoring unit 413 may control displaying of such information on the display apparatus.

Furthermore, when the heating apparatus controls the output of two or more heat sources individually, the monitoring unit may control heating conditions of the two or more heat sources based on the acquired color information. The case with two or more heat sources is not particularly limited but such a case refers to a case with a plurality of heaters or the like, the output of which is individually controllable.

The composition unit 414 may provide a plurality of first images representing small regions of the sheet and compose the plurality of first images to obtain a second image representing a large region of the sheet. In this case, the first acquisition unit 412 may acquire color information of the sheet based on the second image. Furthermore, the processing procedure may be reversed so that the first acquisition unit 412 may acquire a plurality of items of color information of the small regions of the sheet and the composition unit 414 may compose the plurality of items of color information of the small regions to obtain color information of the large region of the sheet.

The display control unit 415 may control displaying of information on control of the heating condition of the heating apparatus by the monitoring unit 413 or information on abnormality in the operating state of the heating apparatus.

The stop unit 416 may stop operation of the heating apparatus in response to detecting a specific abnormality. Here, the specific abnormality is not particularly limited, but examples of the specific abnormality include a case where an average value of thermal history rises above or drops below a predetermined value or a case where a difference between a thermal history of a specific region and a thermal history of another region is equal to or greater than a predetermined value.

### 5.2. Operation Processing

Next, operation of the heating apparatus monitoring apparatus 400 will be described. FIG. 6B is a flowchart illustrating an example of processing carried out by the heating apparatus monitoring apparatus 400.

In step D11, the first acquisition unit 412 of the heating apparatus monitoring apparatus 400 acquires color information on the sheet plane heated by the heating apparatus. In this case, the composition unit 414 may provide a plurality of first images representing small regions of the sheet and compose the plurality of first images to obtain a second image representing a large region of the sheet, and the first acquisition unit 412 may acquire color information of the sheet based on the second image. Similarly, the first acquisition unit 412 may acquire a plurality of items of color information of small regions of the sheet and the composition unit 414 may compose the plurality of items of color information of the small regions to obtain color information of the large region of the sheet.

In step D12, the monitoring unit 413 of the heating apparatus monitoring apparatus 400 controls the heating condition of the heating apparatus based on the acquired color information or detects abnormality in the operating state of the heating apparatus. In this case, as shown in FIG. 6C, the monitoring unit 413 may acquire information on variation in thermal history on the heated sheet plane (step D121), determine whether the variation in thermal history is within a predetermined range (step D122), and when the variation in thermal history is outside the predetermined range, the monitoring unit 413 may control the heating condition of the heating apparatus or detect abnormalities in the operating state of the heating apparatus (step D123).

As shown in FIG. 6C, when the variation in thermal history is within the predetermined range, the monitoring unit 413 of the heating apparatus monitoring apparatus 400 may execute the process of acquiring color information on the sheet plane heated by the heating apparatus again (step D13). This allows the heating condition or the operating state during operation of the heating apparatus to be monitored continuously.

Furthermore, although not shown, the display control unit 415 of the heating apparatus monitoring apparatus 400 may control displaying of control information of the heating condition of the heating apparatus by the monitoring unit 413 or information on abnormality in the operating state of the heating apparatus on the display apparatus.

### 5.3. Monitoring Method

According to the monitoring method of the present embodiment, the heating apparatus monitoring apparatus 400 executes an acquisition step of acquiring color information on the sheet plane heated by the heating apparatus and a monitoring step of controlling the heating condition of the heating apparatus or detecting abnormality in the operating state of the heating apparatus based on the acquired color information.

Note that since specific aspects of the method of the present embodiment have been described in the above-described operation processing, detailed descriptions are omitted here.

### 5.4. Monitoring Program

The monitoring program of the present embodiment causes the heating apparatus monitoring apparatus 400 to execute an acquisition step of acquiring color information on the sheet plane heated by the heating apparatus and a monitoring step of controlling the heating condition of the heating apparatus or detecting abnormality in the operating state of the heating apparatus based on the acquired color information.

The program may be one recorded in a readable recording medium. Note that specific aspects of processing executed by the program of the present embodiment have been described in the above-described operation processing, and so detailed descriptions are omitted here.

### INDUSTRIAL APPLICABILITY

The present invention has industrial applicability as an apparatus or the like for estimating variation in thermal history within a sheet plane heated by a heating apparatus.

### REFERENCE SIGNS LIST

100 . . . thermal history estimation apparatus, 110 . . . processor, 111 . . . transmission/reception unit, 112 . . . first acquisition unit, 113 . . . first estimation unit, 114 . . . composition unit, 115 . . . display control unit, 116 . . . learning unit, 120 . . . communication interface, 130 . . . input/output interface, 133 . . . image pickup apparatus, 135 . . . display apparatus, 140 . . . memory, 150 . . . storage, 151 . . . sheet data, 152 . . . table/model, 160 . . . communication bus, 200 . . . evaluation apparatus, 210 . . . processor, 211 . . . transmission/reception unit, 212 . . . first acquisition unit, 213 . . . second estimation unit, 214 . . . composition unit, 215 . . . display control unit, 216 . . . learning unit, 220 . . . communication interface, 230 . . . input/output interface, 240 . . . memory, 250 . . . storage, 260 . . . communication bus, 300 . . . evaluation apparatus, 310 . . . processor, 311 . . . transmission/reception unit, 312 . . . first acquisition unit, 313 . . . third estimation unit, 314 . . . composition unit, 315 . . . display control unit, 316 . . . learning unit, 320 . . . communication interface, 330 . . . input/output interface, 340 . . . memory, 350 . . . storage, 360 . . . communication bus, 400 . . . monitoring apparatus, 410 . . . processor, 411 . . . transmission/reception unit, 412 . . . first acquisition unit, 413 . . . monitoring unit, 414 . . . composition unit, 415 . . . display control unit, 420 . . . communication interface, 430 . . . input/output interface, 440 . . . memory, 450 . . . storage, 460 . . . communication bus, 600 . . . heating apparatus, 611 . . . first sheet, 612 . . . second sheet, 621 . . . first roll, 622 . . . second roll, 623 . . . third roll, 624 . . . fourth roll, 640 . . . heating unit, 660 . . . control unit

What is claimed is:

1. A thermal history estimation apparatus comprising:
a first acquisition unit that acquires color information on a sheet plane heated by a heating apparatus; and
a first estimation unit that estimates information on variation in thermal history on the sheet plane based on the acquired color information.

2. The thermal history estimation apparatus according to claim 1,
wherein the first acquisition unit acquires the color information on the entire sheet plane.

3. The thermal history estimation apparatus according to claim 1,
wherein the first estimation unit estimates information on variation in thermal history on the sheet plane based on the acquired color information and information on a heating time set in the heating apparatus that heats the sheet.

4. The thermal history estimation apparatus according to claim 1,
wherein the first estimation unit estimates a heating temperature as the thermal history assuming that the heating temperature is constant during a heating time.

5. The thermal history estimation apparatus according to claim 1,
wherein the sheet is a laminated body comprising at least a first layer and a second layer,
the first acquisition unit acquires color information of the second layer as the color information on the sheet plane, and
the first estimation unit estimates information on thermal history of the first layer based on the acquired color information of the second layer.

6. The thermal history estimation apparatus according to claim 1, further comprising:
a composition unit that provides a plurality of first images representing small regions of the sheet and composes the plurality of first images to obtain a second image representing a large region of the sheet,
wherein the first acquisition unit acquires the color information of the sheet based on the second image.

7. The thermal history estimation apparatus according to claim 1,
wherein the first acquisition unit further comprises a composition unit that acquires a plurality of items of color information of small regions of the sheet and composes the plurality of items of color information of the small regions to obtain color information of a large region of the sheet.

8. The thermal history estimation apparatus according to claim 1, further comprising:
a display control unit that controls displaying of the information on variation in thermal history using a heat map corresponding to the sheet plane.

9. The thermal history estimation apparatus according to claim 1, further comprising:
a learning unit that creates a model based on learning data,
wherein the learning data includes the color information of the heated sheet and information on a heating condition thereof, and
the first estimation unit estimates information on variation in thermal history on the sheet plane using the model based on the acquired color information.

10. A heat treated sheet evaluation apparatus comprising:
a first acquisition unit that acquires color information on a sheet plane heated by a heating apparatus; and
a second estimation unit that estimates information on characteristic variation on the sheet plane based on the acquired color information.

11. The heat treated sheet evaluation apparatus according to claim 10, further comprising:
a feedback control unit that performs feedback control of the heating apparatus based on the information on characteristic variation and information on a target characteristic.

12. The heat treated sheet evaluation apparatus according to claim 10,
wherein the second estimation unit estimates information on thermal history of the sheet based on the acquired color information, and estimates the information on characteristic variation on the sheet plane based on the information on thermal history.

13. A heating apparatus evaluation apparatus comprising:
a first acquisition unit that acquires color information on a sheet plane heated by a heating apparatus; and
a third estimation unit that estimates information on characteristic variation on a plane of a heating part of the heating apparatus based on the acquired color information.

14. The heating apparatus evaluation apparatus according to claim 13,
wherein the third estimation unit estimates information on thermal history on the sheet based on the acquired color information, and estimates the information on characteristic variation on the plane of the heating part of the heating apparatus based on the information on thermal history.

15. The heating apparatus evaluation apparatus according to claim 13, further comprising:
a feedback control unit that performs feedback control of the heating apparatus based on the information on characteristic variation on the plane of the heating part and characteristic information on a target plane of the heating part.

16. A heating apparatus monitoring apparatus comprising:
a first acquisition unit that acquires color information on a sheet plane heated by a heating apparatus; and
a monitoring unit that controls a heating condition of the heating apparatus or detects abnormalities in an operating state of the heating apparatus based on the acquired color information.

17. The heating apparatus monitoring apparatus according to claim 16, comprising:
a stop unit that stops operation of the heating apparatus in response to detecting a specific one of the abnormalities.

18. The heating apparatus monitoring apparatus according to claim 16,
wherein the heating apparatus individually controls outputs of two or more heat sources, and
the monitoring unit controls heating conditions of the two or more heat sources based on the acquired color information.
